(19) United States
(12) Patent Application Publication
(10) Pub. No.: US 2014/0164976 A1
(43) Pub. Date: Jun. 12, 2014

(54) INPUT METHOD AND ELECTRONIC DEVICE FOR PROCESSING THE SAME

(71) Applicant: Samsung Electronics Co., Ltd, Gyeonggi-do (KR)

(72) Inventors: Jeong-Hun Kim, Gyeonggi-do (KR); Mi-Hyang Kim, Gyeonggi-do (KR); Kwang-Weon Park, Gyeonggi-do (KR); Yo-Ywang Im, Gyeonggi-do (KR)

(73) Assignee: Samsung Electronics Co., Ltd, Gyeonggi-do (KR)

(21) Appl. No.: 14/098,097

(22) Filed: Dec. 5, 2013

(30) Foreign Application Priority Data
Dec. 6, 2012 (KR) 10-2012-0141270

(51) Int. Cl. G06F 3/0488; G06F 3/041

(52) U.S. Cl. CPC G06F 3/04886; G06F 3/041
USPC 715/773; 345/173

(57) ABSTRACT

A method of enabling a rear input on an electronic device includes dividing one display screen into a first screen and a second screen; displaying an input screen mapped to a first input device on the first screen of a display unit; displaying an input screen mapped to a second input device on the second screen of the display unit; and displaying the input screens mapped to the first and second input devices when entering a character input mode.

### CROSS REFERENCE TO RELATED APPLICATIONS AND CLAIM OF PRIORITY

The present application is related to and claims priority under 35 U.S.C. §119 to an application filed in the Korean Intellectual Property Office on Dec. 6, 2012 and assigned Serial No. 10-2012-0141270, the contents of which are incorporated herein by reference.

### TECHNICAL FIELD

The present disclosure relates generally to a method of inputting and an electronic device thereof.

### BACKGROUND

Due to the recent rapid development of electronic devices, electronic devices enabling wireless voice calls and information exchanges have become daily necessities. The electronic devices have been recognized as simply being able to be portable and make wireless calls at the early stage of propagation, but as the technology develops and wireless internet is introduced, the electronic device is used for the purpose of simple phone calls or schedule management and the applicable range of the electronic device widens to a remote control using near field communication and to capturing an image by using an equipped digital camera to satisfy user demands.

As the electronic provides a multimedia service as described above, an amount of information to be processed and an amount of information to be displayed are increasing. Thus, an interest in an electronic device that has a touch screen is increasing, the touch screen being capable of increasing the size of a display unit by improving spatial utilization.

The touch screen is an input and display device that enables inputting and displaying information to be performed on one screen. Thus, when the touch screen is used, the electronic device may remove a need for a separate input device such as a keypad and thus increase a display area. For example, when a full touch scheme in which the touch screen is applied to the entire screen is used, it is possible to expand the size of a screen by utilizing the front surface of the electronic device as the screen.

The electronic device to which such a touch screen is applied displays a keyboard on the touch screen and enables a user to input characters by touching the displayed keyboard.

### SUMMARY

Embodiments of the present disclosure provide an input method and electronic device for processing the same to substantially solve at least the above problems and/or disadvantages and to provide at least the advantages below. Accordingly, embodiments of the present disclosure provide an input method and device for inputting a character by using a plurality of fingers on an electronic device.

Embodiments of the present disclosure provide a method and device for enabling a rear input by applying a transparent display to an electronic device.

Certain embodiments of the present disclosure provide a method and device for enabling a rear input by separating an input screen mapped to front keys from an input screen mapped to rear keys on an electronic device and simultaneously displaying the separated input screens on one screen.

Certain embodiments of the present disclosure is to provide a method and device for enabling a rear input by arranging a first group of characters (function keys) and a second group of characters (alphabet keys) on different surfaces of an electronic device.

According to embodiments of the present disclosure, a method of enabling a rear input on an electronic device includes dividing one display screen into a first screen and a second screen; displaying an input screen mapped to a first input device on the first screen of a display unit; displaying an input screen mapped to a second input device on the second screen of the display unit; and displaying the input screens mapped to the first and second input devices when entering a character input mode.

The input screen mapped to the first input device and the input screen mapped to the second input device can include different components.

The displaying of the input screens mapped to the first and second input devices when entering a character input mode can include displaying the input screens on a transparent display unit.

The displaying of the input screens mapped to the first and second input devices when entering a character input mode can include applying different effects to the input screen mapped to the first input device and the input screen mapped to the second input device for distinguishing the input screens.

The displaying of the input screens mapped to the first and second input devices when entering a character input mode can include creating different layers and then displaying the input screen mapped to each input device on each of generated layers.

The displaying of the input screens mapped to the first and second input devices when entering a character input mode can include applying a specific effect to a component on which a user gesture is sensed and distinguishing the component from other components on which the user gesture is not sensed.

The components of the input screen mapped to the first input device or the second input device can vary.

Certain embodiments of the present disclosure include an electronic device for enabling a rear input includes a display unit displaying an input screen mapped to an input device on each of first and second screens; and at least one processor dividing one display screen into the first screen and a second screen, displaying the input screen mapped to a first input device on the first screen of the display unit, displaying the input screen mapped to a second input device on the second screen of the display unit, and displaying the input screens mapped to the first and second input devices when entering a character input mode.

The processor allows the input screen mapped to the first input device and the input screen mapped to the second input device to include different components.

The display unit includes a transparent display.

The processor allows different effects to be applied to the input screen mapped to the first input device and the input screen mapped to the second input device to distinguish the input screens.

The processor allows different layers to be created and then allow the input screen mapped to each input device to displayed on each of generated layers.

The processor applies a specific effect to a component on which a user gesture is sensed, to allow the component be distinguished from other components on which the user gesture is not sensed.

The processor allows the components of the input screen mapped to the first input device or the second input device to vary.

Certain embodiments of the present disclosure include a computer readable recording medium includes instructions to allow an electronic device to divide one display screen into a first screen and a second screen; display an input screen mapped to a first input device on the first screen of a display unit; display an input screen mapped to a second input device on the second screen of the display unit; and display the input screens mapped to the first and second input devices when entering a character input mode, when executed by the electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device for enabling a rear input according to embodiments of the present disclosure;

FIG. 2 illustrates a flow chart of a process of providing a rear input function by an electronic device according to embodiments of the present disclosure;

FIGS. 3A to 3C illustrate an electronic device enabling a rear input according to embodiments of the present disclosure;

FIGS. 4A to 4C illustrate an electronic device enabling a rear input according to embodiments of the present disclosure;

FIGS. 5A to 5C illustrate an electronic device enabling a rear input according to embodiments of the present disclosure; and

FIGS. 6A and 6B illustrate a character input process of an electronic device according to embodiments of the present disclosure.

### DETAILED DESCRIPTION

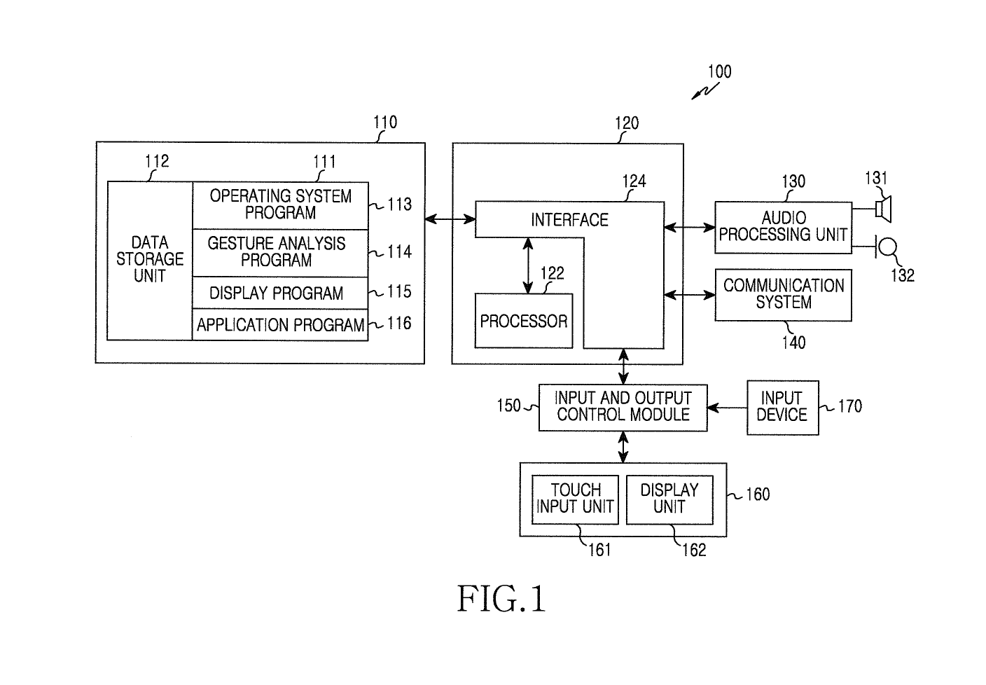

FIGS. 1 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Embodiments of the present disclosure will be described below in more detail with reference to the accompanying drawings. Moreover, detailed descriptions related to well-known functions or configurations may be omitted in order not to unnecessarily obscure subject matters of the present disclosure. The terms described below are those defined by considering the functions in embodiments of the present disclosure and may vary depending on the intention or of a user or an operator or practice. Therefore, the definitions will be made on the basis of the contents throughout the specification.

In general, a user holds an electronic device with one or both hands and touches a keypad displayed on the touch screen of the electronic device. In this case, fingers other than thumb are typically located on the rear surface of the electronic device and only the thumb is located on the front surface of the electronic device, so the user inputs characters by using only the thumb.

A character input method in which only the thumb is used as described above has a drawback in that a character input speed is slow as compared to a general computer keyboard.

In addition, because the size of the touch screen is limited, a region assigned to each character is narrow when assigning all characters of a keyboard. Thus, when inputting a character, there is a drawback in that neighboring characters near a character that a user wants to select are selected.

In order to solve the drawback, it is possible to use a voice recognition technology or an expandable input device such as an external keyboard. However, in the case of the expandable input device, there are drawbacks in that portability may decrease and it is inconvenient to use while moving.

In addition, in the case of the voice recognition, it is possible to input a character without directly pressing a keyboard but there are drawbacks in that a voice recognition rate may decrease due to pronunciation or accent and it is possible to invade privacy due to a voice input or personal information may be easily exposed.

In the following, a device and method will be described which predict the moving location of a finger located at a rear surface of an electronic device according to the present disclosure by simultaneously displaying an input screen mapped to an input device of a front surface of the electronic device and an input screen mapped to an input device of a rear surface thereof.

Such an electronic device includes a transparent or opaque input device and enables a character input by sensing a gesture of a user on the input devices that are arranged on the front and rear surfaces.

Moreover, the gesture in the specification means forming a touch pattern on a touch screen of the electronic device. A touch is made on a touch screen of the electronic device by a user finger or an external input unit such as a touch pen, and the gesture means forming a certain pattern of drag while maintaining the touch on the touch screen. In some cases, the gesture includes the release of the drag while maintaining the touch and the release of the touch.

In addition, the electronic device can be a portable electronic device and can be a device such as a portable terminal, a mobile phone, a media player, a tablet computer, a handheld computer or a Personal Digital Assistant (PDA). Moreover, the electronic device can be any potable electronic device that includes a device having the functions of two or more of these devices.

FIG. 1 is a block diagram of an electronic device for enabling a rear input according to the present disclosure.

As shown in FIG. 1, an electronic device 100 includes a memory 110, a processor unit 120, an audio processing unit 130, a communication system 140, an input and output control unit 150, a touch screen 160, and an input device 170. Here, at least one of the components can be configured in plural. According to an embodiment, the electronic device 100 may include a plurality of memories or a plurality of communication systems 140.

The memory 110 includes a program storage unit 111 that stores programs for controlling the operation of the electronic device 100 and a data storage unit 112 that stores data generated while executing programs. For example, the data storage unit 112 stores updatable keeping data such as telephone numbers, sent messages and received messages and also store images of the input screens mapped to the input devices of the front and rear surfaces according to the present disclosure. As an example, the input screen mapped to the input device of the front surface can be an input screen including some of the components of a virtual keyboard and the input screen mapped to the input device of the rear surface can be an input screen including the others of the components thereof.

In addition, the data storage unit 112 stores a user gesture to select a component of the input screen.

Moreover, the program storage unit 111 includes an operating system (OS) program 113, a gesture analysis program 114, a display program 115, and at least one application program 116. Here, the programs in the program storage unit 111 are a set of instructions and can be represented as an instruction set.

The OS program 113 includes several software components that control general system operations. The general system operation control includes, for example, memory control and management, storage hardware (device) control and management, and power control and management. The OS program also performs a function of making communication between a lot of hardware (devices) and program components (modules) smooth.

The gesture analysis program 1104 analyzes a user gesture to select a component that configures the input screen.

As an example, it is possible to analyze a user gesture on the front surface and a user gesture on the rear surface by using a gesture to select a component to be input.

In addition, the gesture analysis program 114 analyzes a user gesture and then delivers an analyzed result to the display program 115.

The display program 115 includes several software components for providing and displaying a graphic on the touch screen 160. The term graphic may indicate a text, a web page, an icon, a digital image, a video, animation, etc.

In addition, the display program 115 includes several software components related to a user interface.

That is, the display program 115 displays the input screen and allow a character input mode to be performed.

In this case, the display program 115 changes a display type according to the configuration of the display unit 162 of the electronic device.

As an example, when the electronic device uses one display unit, the display program 115 simultaneously displays two input screens. As another example, if the electronic device uses two transparent display units, the display program 115 displays different input screens on the display units. That is, the display program 115 creates two layers and displays the input screen of the front surface on one layer and the input screen of the rear surface on the other layer so that the two layers may be overlap-displayed.

In addition, the display program 115 applies different effects to the input screens so that the input screen of the front surface and the input screen of the rear surface may be distinguished for display.

In addition, the display program 115 applies a specific effect to a component selected by a user gesture among displayed components so that a component selected currently by a user can be distinguished from a component that is not selected.

The application program 116 includes software components for at least one application program that is installed in the electronic device 100. As an example, a character input function that enables the input screen of the front surface and the input screen of the rear surface to be simultaneously displayed may also be a type of the application program 116.

The program in the program storage unit 111 is operated by a hardware component. According to an embodiment, the electronic device 100 includes a gesture analysis module, a display module, etc.

The processor unit 120 includes at least one processor 122 and an interface 124. Here, the processor 122 and the interface 124 can be integrated as at least one integrated circuit (IC) or implemented as separate components.

The interface 124 functions as a memory interface that controls accesses to the processor 122 and the memory 110.

In addition, the interface 124 functions as a peripheral interface that controls the connection between the input and output devices of the electronic device 100 and the processor 122.

The processor 122 executes at least one program and instructs to perform a function corresponding to that program. For example, the processor 122 includes a display processor that displays the input screens of the front and rear surfaces to sense a user gesture on the front and the rear surfaces.

The audio processing unit 130 provides an audio interface between a user and the electronic device 100 through a speaker 131 and a microphone 132.

The communication system 140 performs a communication function for voice and data communications of the electronic device 100. In this case, the communication system is divided into a plurality of communication sub modules that support different communication networks. For example, the communication network includes a Global System for Mobile Communication (GSM) network, an Enhanced Data GSM Environment (EDGE) network, a Code Division Multiple Access (CDMA) network, a W-Code Division Multiple Access (W-CDMA) network, an Long Term Evolution (LTE) network, an Orthogonal Frequency Division Multiple Access (OFDMA) network, a wireless LAN, a Bluetooth network, and an Near Field Communication (NFC) network but is not limited thereto.

The input and output control unit 150 provides a connection between the input and output devices such as the touch screen 160 and the input device 170 and an interface.

The touch screen 160 is an input and output device that outputs and inputs information, and can include a touch input unit 161 and a display unit 162.

The touch input unit 161 provides touch information sensed through a touch panel to the processor unit 120 through the input and output control unit 150. In this case, the touch input unit 161 changes the touch information to a command structure such as touch_down, touch_move, and touch_up and provides the command structure to the processor unit 120 to generate a user gesture for selecting a component of an input screen according to the present disclosure. The touch input unit 161 can be arranged on both the front and rear surfaces of the electronic device.

The display unit 162 displays state information on the electronic device 100, and characters, moving pictures, and still pictures that are input by a user. For example, the display unit 162 displays input screens mapped to the input devices of front and rear surfaces of the electronic device 100. According to an embodiment, a layer including the input screen of the front surface and a layer including the input screen of the rear surface can be overlap-displayed on the display unit 162.

The input device 170 provides input data generated by the selection of a user to the processor unit 120 through the input and output control unit 150. For example, the input unit 170 includes only a control button for controlling the electronic device 100. As another example, the input unit 170 includes a keypad for receiving input data from a user and generate a user gesture for selecting a component of an input screen according to the present disclosure.

Although not shown, the electronic device 100 can further include components for providing additional functions such as a camera module for capturing images or moving pictures, a broadcast reception module for receiving broadcasts, a digital sound source playing module such as an MP3 module, a near filed communication module for near field communication, and a proximity sensor module for proximity sensing, and software for operating these components.

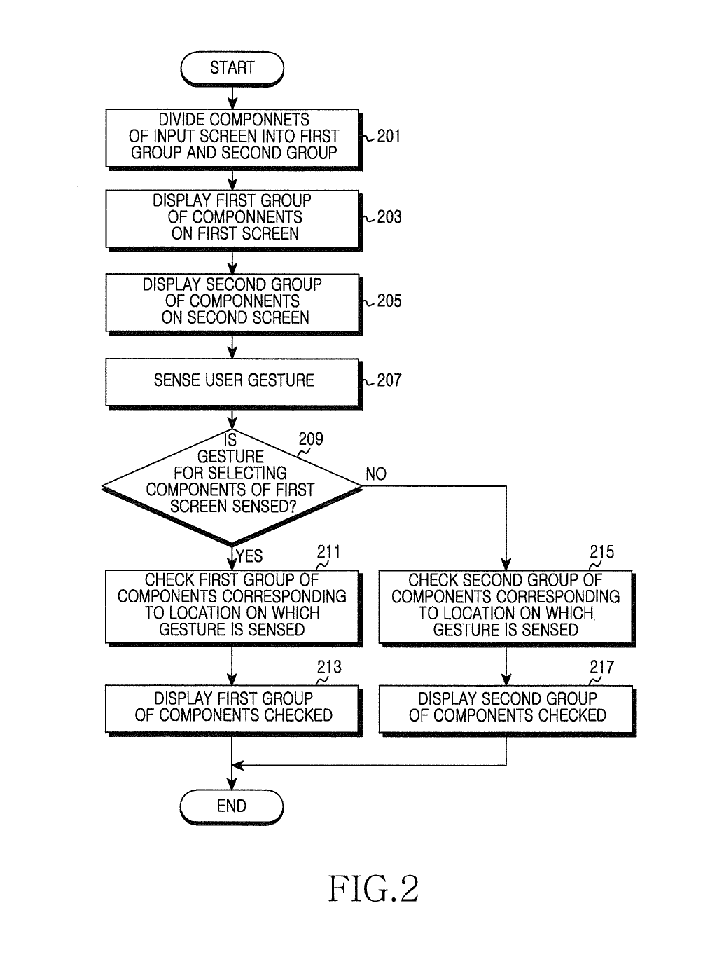

FIG. 2 is a flow chart of a process of providing a rear input function by an electronic device according to the present disclosure.

Referring to FIG. 2, the electronic device includes a plurality of input devices in order to sense a user gesture on the front and rear surfaces of the electronic device according to the present disclosure.

As an example, the electronic device includes a touch screen including one display unit and two touch input units (touch sensors) (for example, the touch input units being respectively attached to the front and rear surfaces of the display unit) to be able to sense a user gesture on the front and rear surfaces of the electronic device.

In addition, the electronic device includes a touch screen on one surface thereof and a key pad on the other surface thereof to be able to sense a user gesture on the front and rear surfaces of the electronic device.

That is, a user of the electronic device according to the present disclosure generates a gesture for inputting a character with a finger that is placed on the front or rear surface of the electronic device.

Firstly, the electronic device classifies components of an input screen into a first group and a second group in block 201. Here, the input screen is a screen that displays information mapped to a certain region of an input device as a graphic and can be a virtual keyboard that is displayed through a display unit. Each piece of information (a character) that configures such an input screen (virtual keyboard) becomes a component.

In addition, the electronic device maps different groups of components to a first input device (input device of a front surface) and a second input device (input device of a rear surface). This means that the components of the input screen corresponding to the first input device is different from those of the input screen corresponding to the second input device.

As an example, the electronic device allows function keys (ALT, TAB, CTRL, ENTER, BACKSPACE, arrow, HOME, END, PAGEUP, and PAGEDOWN keys, etc.) configuring a virtual keyboard to be input by using the first input device and the other keys (alphabets and Korean characters, etc.) excluding the function keys to be input by using the second input device.

Thus, it is possible to form one virtual keyboard by combining the first group of components with the second group of components.

Subsequently, the electronic device proceeds to block 203 to display an input screen including the first group of components (a first input screen) on a first screen of a display unit and proceeds to block 205 to display an input screen including the second group of components (a second input screen) on a second screen of the display unit.

In this case, the electronic device simultaneously displays the first input screen and the second input screen on one display unit and processes to create a screen such as a plurality of layers, a window, etc. and display different groups of components on each of the produced screens.

When the electronic device creates a plurality of layers on a display screen and displays a component, the created layers displayed become the first screen and the second screen on which an input screen is displayed.

Such an electronic device includes a transparent display unit (transparent display). In this case, a user of the electronic device may see a finger on the rear surface of the electronic device with his/her eyes by using the transparent display unit. In this case, the user of the electronic device may check his/her fingers on the displayed second input screen and the rear surface and select a second group of components. According to an embodiment, the electronic device display the second group of components to be selected, by using user fingers.

The electronic device can include an opaque display unit. In this case, the user may not check a user's finger location on the rear surface of the electronic device but approximately check a location to which the fingers will be placed on the displayed second input screen.

According to an embodiment, a user who holds the electronic device controls the input device of the front surface with fingers on the front surface by using the displayed first input screen and controls the input device of the rear surface with fingers on the rear surface by using the displayed second group of components.

Subsequently, the electronic device proceeds to block 207 to sense a user gesture for selecting a component of a displayed input screen and then proceeds to block 209 to check whether a gesture for selecting a first group of components (components displayed on the first screen) is sensed. Here, the gesture for selecting the first group of components indicates a gesture that is sensed from an input device to which the first group of components is mapped.

If in block 209, a gesture for selecting the first group of components is sensed, the electronic device proceeds to block 211 to check the first group of components corresponding to a location on which a user gesture is sensed, and then proceeds to block 213 to allow the checked first group of components to be displayed. In this case, the electronic device checks the components selected by the user gesture, then applies a specific effect to the selected components and displays so that the selected components are distinguished from components that are not selected.

On the other hand, if in block 209, a gesture for selecting the second group of components is sensed, the electronic device proceeds to block 213 to check the second group of components corresponding to a location on which a user gesture is sensed and then proceed to block 217 to allow the checked second group of components to be displayed. In this case, the electronic device checks the components selected by the user gesture, then apply a specific effect to the selected components and display so that the selected components are distinguished from components that are not selected.

FIG. 2 describes how to enable a rear input by using an electronic device having one display unit but the electronic device according to embodiments of the present disclosure includes two transparent display units.

As an example, the electronic device includes a touch screen including a touch input and a display unit on the front and rear surfaces of the electronic device

In this case, the electronic device maps different groups of components to a display unit of a first touch screen (touch screen of the front surface) and a display unit of a second touch screen (touch screen of the rear surface). As an example, the electronic device displays functions keys (ALT, TAB, CTRL, ENTER, BACKSPACE, arrow, HOME, END, PAGEUP, PAGEDOWN keys, etc.) configuring a virtual keyboard on the display unit of the first touch screen and display the other keys excluding the function keys (alphabets, Korean characters, etc.) on the display unit of the second touch screen.

When components are displayed on the display unit of the first touch screen and the display unit of the second touch screen, a user of the electronic device may check components displayed on the touch screen of the rear surface through the transparent touch screen of the front surface and in addition, he/she may also check his/her fingers on the rear surface.

The user of the electronic device can control the touch screen of the front surface with his/her thumb by using a first group of components displayed and can control the touch screen of the rear surface with his/her fingers excluding the thumb by using a second group of components displayed.

Even in this case, it is possible to simultaneously display different input screens on one display unit.

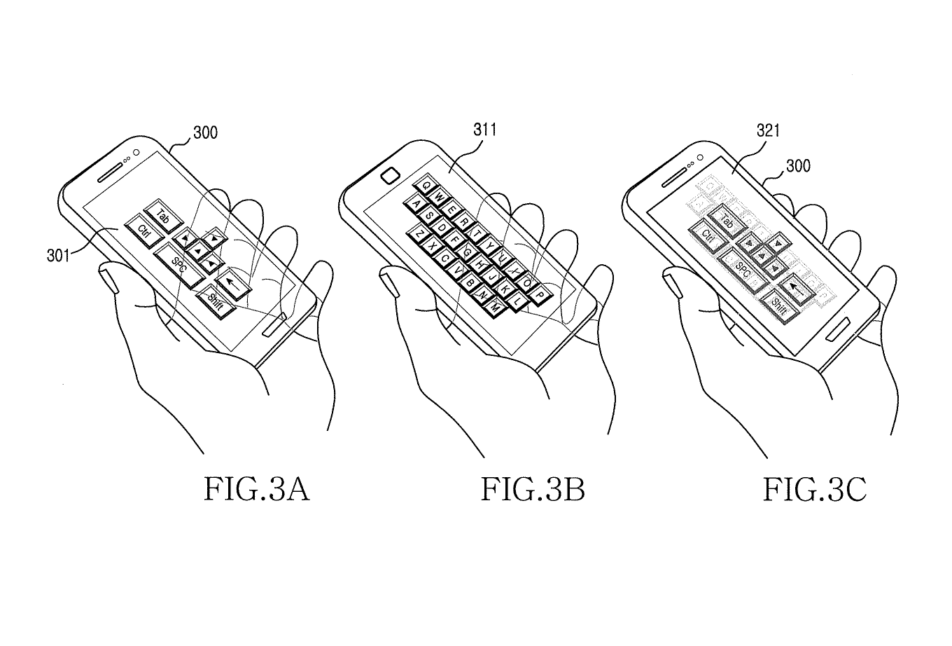

FIGS. 3A to 3C show an electronic device enabling a rear input according to embodiments of the present disclosure.

Referring to FIGS. 3A to 3C, the electronic device includes a plurality of touch input units and includes a touch screen that senses user gestures on the front and rear surfaces of the electronic device according to embodiments of the present disclosure.

A general touch screen includes one display unit and one touch input unit and may sense a user gesture on the touch input unit (front surface of the electronic device).

However, the touch screen of the electronic device according to an embodiment of the present disclosure includes one display unit and two touch input units and it is possible to sense user gestures on the front and rear surfaces of the electronic device by arranging the touch input units on the front and rear surfaces of the display unit, respectively.

A transparent display is installed at the electronic device so that a user may check an object behind the display unit with his/her eyes.

The electronic device maps input screens having different components to the touch input units and displays them on one screen. The input screen is a screen that displays characters mapped to certain regions of an input device as graphics, and can be a displayed virtual keyboard. Keys (characters) configuring the input screen are components of the input screen.

According to an embodiment, the electronic device processes so that different input screens mapped to a first touch input and a second touch input unit are simultaneously displayed on one screen.

As an example, the electronic device maps an input screen including function keys of a virtual keyboard to the first touch input unit as shown in FIG. 3A and maps an input screen including other keys excluding the function keys to the second touch input unit as shown in FIG. 3B.

FIG. 3A shows a front surface 300 of the electronic device on which TAB, CTRL, BACKSPACE, arrow, SPACE, and SHIFT keys are mapped 301 to the first touch input unit (corresponding to the front surface 300) and a user of the electronic device may make a gesture on the first touch input unit of the front surface 300 to select a function key.

The electronic device as shown in FIGS. 3A to 3C includes a transparent display unit, so a user of the electronic device can also check the locations of his/her fingers on the rear surface of the electronic device.

FIG. 3B shows the rear surface 311 of the electronic device on which alphabet keys are mapped to the second touch input unit (corresponding to the rear surface) and a user of the electronic device may make a gesture on the second touch input unit of the rear surface to select a desired character and may also check through the rear surface on which the fingers of the user holding the electronic device are placed.

Such an electronic device simultaneously displays 321, on one display unit, input screens mapped to the touch input unit of the front surface 300 and the touch input unit of the rear surface 311 as shown in FIG. 3C.

According to an embodiment, the electronic device creates two layers on a display region to display an input screen mapped to the first touch input unit on one layer and display an input screen mapped to the second touch input unit on the other layer. Since such layers are transparent, they are displayed as overlapping (also referred to as overlap-displayed).

It is possible to widen regions for components included in each input screen by displaying the components of the input screens on two layers.

Thus, a user who uses the electronic device displaying input screens as shown in FIG. 3C checks, with his/her eyes, the components of the first touch input unit (first components) displayed on the display unit and makes a gesture for selecting a function key on the first touch input unit. In addition, the user may make a gesture for selecting a desired character on the second touch input unit by using the components of the second touch input unit (second components) displayed on the display unit and his/her finger locations checked with his/her eyes.

In general, when a user holds the electronic device, user's thumb is placed on the front surface 300 of the electronic device and the other fingers are placed on the rear surface thereof. This matter means that it is possible to make gestures with only thumb on the first touch input unit and with the other fingers on the second touch input unit.

In other words, it means that it is possible to select more components with the other fingers on the rear surface than the thumb on the front surface. According to the present disclosure, functions keys that correspond to less components are assigned to the first touch input unit. However, the components mapped to the first touch input unit and the second touch input unit can vary depending on user selection. As an example, a user can map Korean consonant letters to the first touch input unit and Korean vowel letters to the second touch input unit.

The electronic device applies different effects to layers to clearly distinguish the input units mapped to the front 300 and rear 311 surfaces and display a first group components and a second group of components. As an example, it is possible to distinguish the components of the first layer from the components of the second layer by using colors.

The electronic device applies a specific effect to a component selected by a user gesture among displayed components to distinguish a component currently selected by a user from components that are not selected.

The electronic device displays different groups of components by using two transparent touch screens. That is, the electronic device displays the first group of components on a first touch screen and the second group of components on a second touch screen.

Since the touch screen of the electronic device is transparent, a user recognizes that the components of the first touch screen and the components of the second touch screen are displayed on one screen.

According to an embodiment, since a user of the electronic device may check, through the first touch screen, components displayed on the second touch screen and user fingers on the rear surface with his/her eyes, he/she can accurately make a gesture for selecting components mapped to the rear surface 311.

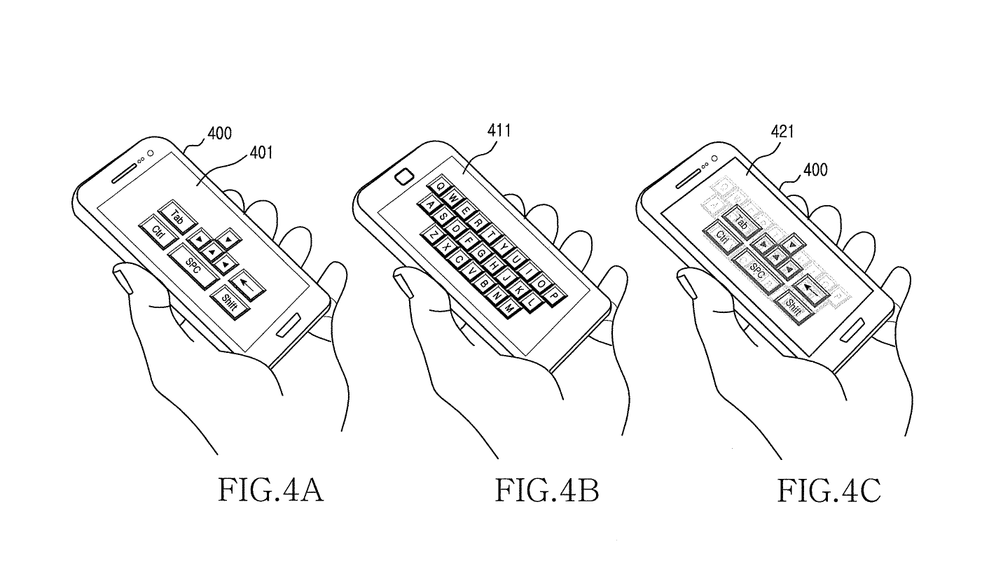

FIGS. 4A to 4C show an electronic device enabling a rear input according to embodiments of the present disclosure.

Referring to FIGS. 4A to 4C, the electronic device includes a plurality of touch input units and according to the present disclosure, the electronic device includes touch screens having touch input units on the front and rear surfaces of a display unit in order to sense user gestures on the front and rear surfaces. In this case, since the electronic device includes an opaque display, it is not possible to check an object behind the display unit with user eyes.

The electronic device generates input data for the components mapped to touch input units. According to an embodiment, the electronic device maps different group of components to the first touch input unit and the second touch input unit, the first touch input unit allows a user to select a first group of components and the second touch input unit allows a user to select a second group of components.

As an example, the electronic device maps function keys of a virtual keyboard to the first touch input unit as shown in FIG. 4A and map other keys excluding the function keys to the second touch input unit as shown in FIG. 4B.

FIG. 4A shows a front surface 400 of the electronic device on which TAB, CTRL, BACKSPACE, arrow, SPACE, and SHIFT keys are mapped 401 to the first touch input unit (corresponding to the front surface).

The electronic device as shown in FIGS. 4A to 4C includes an opaque display unit, so a user of the electronic device may not check the locations of his/her fingers on the rear surface of the electronic device.

FIG. 4B shows the rear surface 411 of the electronic device on which alphabet keys are mapped to the second touch input unit (corresponding to the rear surface) and a user of the electronic device may make a gesture on the second touch input unit to select a desired character.

Such an electronic device simultaneously displays 421, on one display unit, components mapped to the touch input unit of the front surface 400 and the touch input unit of the rear surface 411 as shown in FIG. 4C. That is, the electronic device creates two transparent layers on a display unit to display components mapped to the first touch input unit on one layer and display components mapped to the second touch input unit on the other layer. Since such layers are transparent, they can be overlap-displayed.

Thus, a user of the electronic device displaying the components as shown in FIG. 4C checks the components of the first touch input unit (first components) displayed on the display unit with his/her eyes and makes a gesture for selecting a function key on the first touch input unit.

In addition, since the electronic device includes an opaque display, a user may not check the fingers on the rear surface with his/her eyes but may determine a location to which his/her fingers move, by using the components of the second touch input unit (second components) displayed on the display unit.

That is, since the display unit of the electronic device is not transparent, the user may not directly check the locations of his/her fingers but can approximately determine a location to which the fingers move, by using the locations of the second components displayed.

Although the number of the second components is more than that of the first components in FIGS. 4A to 4C, the number of the second components can be less in the case of an opaque display.

The reason for this is that an area of an input unit is limited and if the number of components increases, a region to which each component is assigned will narrow. That is, when a user may not check the locations of his/her fingers, it is more likely for the user to select other components near a desired component having a narrow region, not the desired component.

A user of the electronic device as shown in FIG. 4C may touch the first components displayed to input function keys and in addition, can correctly input characters corresponding to the second touch input unit based on the second components displayed.

The electronic device applies different effects to the first group of components and the second group of components and then display the components on the display unit. As an example, the electronic device can distinguish the first group of components from the second group of components by using different layers, windows or colors for display.

The electronic device applies a specific effect to a component selected by a user gesture among the displayed components to distinguish the component currently selected by a user from components that are not selected.

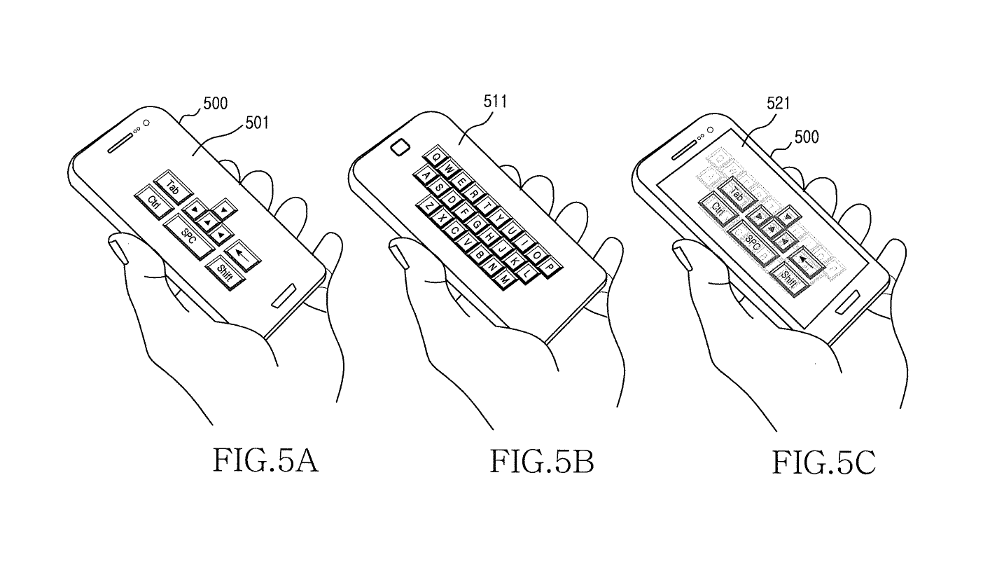

FIGS. 5A to 5C show an electronic device enabling a rear input according to embodiments of the present disclosure.

Referring to FIGS. 5A to 5C, the electronic device includes a plurality of input devices and according to the present disclosure, a touch screen is installed on the front surface of the electronic device and an input device such as a key pad is installed on the rear surface thereof.

The electronic device generates input data for the component mapped to each touch screen. That is, the touch screen and the key pad of the electronic device generate input data for different groups of components and the touch screen allows a user to select a first group of components and the key pads allows a user to select a second group of components. Here, the components indicate characters mapped to creation regions of the touch screen.

As an example, the electronic device may map function keys of a virtual keyboard to the touch screen as shown in FIG. 5A and map other keys excluding the function keys to the key pad as shown in FIG. 5B.

FIG. 5A displays 501 functions keys mapped to the touch screen corresponding to the fronts surface 500 of the electronic device and since the electronic device includes an opaque touch screen, so a user of the electronic device may not see his/her fingers on the rear part of the touch screen on which the function keys are displayed.

FIG. 5B shows the rear surface 511 of the electronic device on which the key pad including a plurality of keys is arranged.

Such an electronic device simultaneously displays 521 components mapped to the key pad of the rear surface 511 on the touch screen of the front surface as shown in FIG. 5C.

The display 521 provides the location of the component to be selected by a user finger by displaying components mapped to the touch screen of the rear surface of the electronic device on the touch screen of the front surface 500.

Such an electronic device may not guide the location of the user finger because its touch screen is not transparent, a user may approximately check a location to which the finger will move, by using the components mapped to the rear surface displayed on the touch screen of the front surface.

In this case, it is possible to decrease the number of the components mapped to the rear surface 511 of the electronic device.

The reason for this is that if the number of components mapped to the rear surface 511 increases, a region to which each component is assigned narrows and a user may not check the locations of his/her fingers and thus there may be a drawback in that a user selects other components near a desired component.

A user of the electronic device as shown in FIG. 5C may touch the components displayed on the touch screen of the front surface 500 of the electronic device to input function keys and in addition, may check the components mapped to the key pad of the rear surface 510 displayed on the front surface 500, with his/her eyes. Thus, the user can check the components mapped to the touch screen of the rear surface of the electronic device and input the components corresponding to the rear surface with his/her fingers placed on the rear surface.

A mark defining the locations of fingers can be added to at least one of keys on the key pad of the rear surface 511. Thus, a user of the electronic device may check the locations of fingers without seeing the key pad and by touching the mark.

The electronic device applies different effects to the first group of components and the second group of components and then display the components on the touch screen of the front surface. As an example, the electronic device distinguishes the first group of components from the second group of components by using different layers, windows or colors for display.

The electronic device applies a specific effect to a component selected by a user gesture among the displayed components to distinguish the component currently selected by a user from components that are not selected.

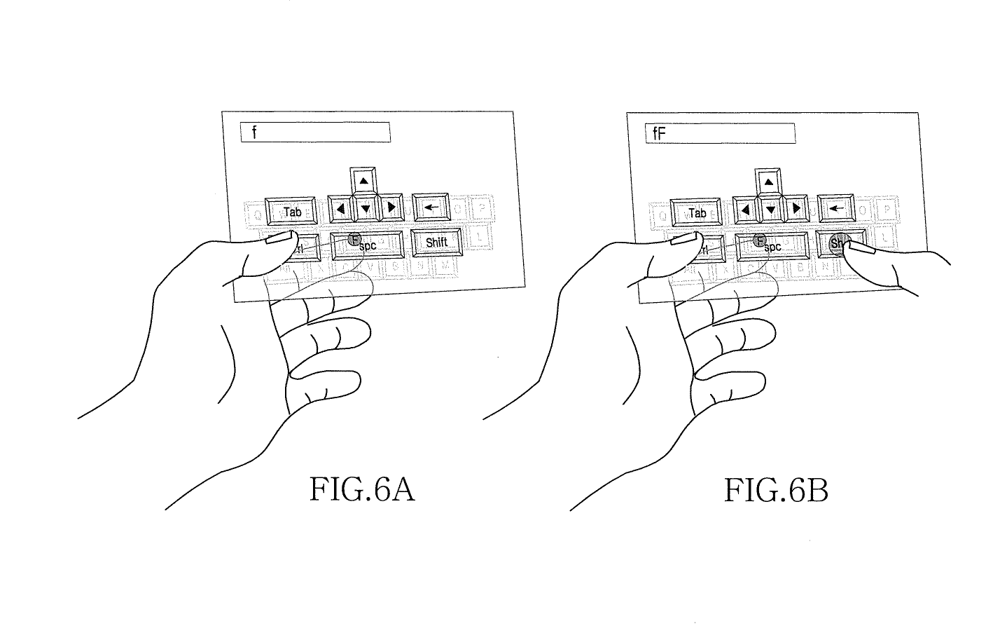

FIGS. 6A and 6B illustrate a character input process of an electronic device according to embodiments of the present disclosure.

Referring to FIGS. 6A and 6B, the electronic device includes a plurality of input devices and according to embodiments of the present disclosure, a first touch input unit and a second input unit are arranged on the front and rear surfaces of the electronic device and such a touch screen is formed of a transparent material, so it is possible to see user hands on the rear surface of the electronic device.

For the electronic device, input devices are attached to the front and rear surfaces of a transparent display unit. In addition, the display unit and the input devices operate according to the control of a processor, which generates a visual or tactile feedback according to a user gesture sensed by an input unit.

The electronic device displays an image for a front input device that includes numbers, symbols, function keys (Shift, Enter, Back Space. Delete keys, etc.) and a Space bar among components of a keyboard such as a QWERTY keyboard or a standard keyboard.

The electronic device displays an image for a rear input device that includes a set of real characters excluded from the image for the front input device.

If a character input mode is executed, the electronic device displays the image for the front input device and the image for the rear input device. In this case, the electronic device displays each image on different layers and a user will select the keys of the front surface by using the image for the front input device and the keys of the rear surface by using the image for the rear input device.

This enables a touch input from the front and rear surfaces of the electronic device with the fingers of a user who holds the electronic device, and the user makes a gesture on the front surface with a finger on the front surface and a gesture on the rear surface with fingers on the rear surface.

In this case, since function keys are mainly arranged on the image for the front input device according to an embodiment as shown in FIGS. 6A and 6B, the electronic device holds when a function key such as Shift key capable of being combined with another key among the function keys of the front surface is pressed, and then processes a corresponding event when the front surface is touched.

That is, if the alphabet “f” of the rear surface is input as shown in FIG. 6A, the alphabet f is displayed on an input window, and if the alphabet “f” of the rear surface is input while the Shift key of the front surface is pressed as shown in FIG. 6B, the alphabet F is displayed on the input window. The Shift key of the front surface has a characteristic that allows a capital letter to be input, so the characteristic is applied to the key input following the Shift key.

According to an electronic device and method that enable a rear input, a plurality of input devices (for example, two transparent touch screens) are arranged on different surfaces of the electronic device and a first group of characters (function keys) and a second group of characters (character keys) are mapped to the input devices to enable a rear input, so regions for characters assigned to the input units widen and a user can correctly select a desired character.

It will be appreciated that embodiments of the present disclosure according to the claims and description in the specification can be realized in the form of hardware, software or a combination of hardware and software. Any such software can be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software is stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Accordingly, embodiments provide a program comprising code for implementing apparatus or a method as claimed in any one of the claims of this specification and a machine-readable storage storing such a program. Still further, such programs are conveyed electronically via any medium such as a communication signal carried over a wired or wireless connection and embodiments suitably encompass the same.

While particular embodiments have been described in the detailed description of the present disclosure, several variations may be made without departing from the scope of the present disclosure. Therefore, the scope of the present invention should not be limited to the above-described embodiments but be defined by the following claims and equivalents thereof.

What is claimed is:

1. A method in an electronic device, the method comprising:
displaying an input screen mapped to a first input device on a first screen of a display unit;
displaying an input screen mapped to a second input device on a second screen of the display unit; and
displaying the input screens mapped to the first and second input devices when entering a character input mode.

2. The method of claim 1, wherein the input screen mapped to the first input device and the input screen mapped to the second input device comprise different components.

3. The method of claim 1, wherein the displaying of the input screens mapped to the first and second input devices when entering a character input mode comprises displaying the input screens on a transparent display unit.

4. The method of claim 1, wherein the displaying of the input screens mapped to the first and second input devices when entering a character input mode comprises applying different effects to the input screen mapped to the first input device and the input screen mapped to the second input device for distinguishing the input screens.

5. The method of claim 1, wherein the displaying of the input screens mapped to the first and second input devices when entering a character input mode comprises creating different layers and then displaying the input screen mapped to each input device on each of generated layers.

6. The method of claim 1, wherein the displaying of the input screens mapped to the first and second input devices when entering a character input mode comprises applying a specific effect to a component on which a user gesture is sensed and distinguishing the component from other components on which the user gesture is not sensed.

7. The method of claim 1, wherein the components of the input screen mapped to the first input device vary.

8. The method of claim 1, wherein the components of the input screen mapped to the second input device vary.

9. An electronic device for enabling a rear input, the electronic device comprising:
a display unit configured to display an input screen mapped to an input device on each of first and second screens; and
at least one processor configured to: divide one display screen into the first screen and a second screen, display the input screen mapped to a first input device on the first screen of the display unit, display the input screen mapped to a second input device on the second screen of the display unit, and display the input screens mapped to the first and second input devices when entering a character input mode.

10. The electronic device of claim 9, wherein the least one processor is further configured to include different components in the input screen mapped to the first input device than in the input screen mapped to the second input device.

11. The electronic device of claim 9, wherein the display unit comprises a transparent display.

12. The electronic device of claim 9, wherein the processor is further configured to apply different effects to the input screen mapped to the first input device and to the input screen mapped to the second input device to distinguish the input screens.

13. The electronic device of claim 9, wherein the processor is further configured to create different layers, and then to display the input screen mapped to each input device on each of generated layers.

14. The electronic device of claim 9, wherein the processor is further configured to apply a specific effect to a component on which a user gesture is sensed, to allow the component be distinguished from other components on which the user gesture is not sensed.

15. The electronic device of claim 9, wherein the processor is further configured to allow the components of the input screen mapped to the first input device.

16. The electronic device of claim 9, wherein the processor is further configured to allow the components of the input screen mapped to the second input device to vary.

17. A non-transitory computer readable recording medium storing one or more programs that comprise instructions that, when executed by processing circuitry, causes the processing circuitry to:
display an input screen mapped to a first input device on a first screen of a display unit;
display an input screen mapped to a second input device on a second screen of the display unit; and
display the input screens mapped to the first and second input devices when entering a character input mode.

18. The non-transitory computer readable recording medium of claim 17, wherein the input screen mapped to the first input device and the input screen mapped to the second input device comprise different components.

19. The non-transitory computer readable recording medium of claim 17, wherein the instructions that cause the processing circuitry to display of the input screens mapped to the first and second input devices when entering a character input mode comprise instructions that, when executed by processing circuitry, causes the processing circuitry to:
display the input screens on a transparent display unit.

20. The non-transitory computer readable recording medium of claim 17, wherein the instructions that cause the processing circuitry to display of the input screens mapped to the first and second input devices when entering a character input mode comprise instructions that, when executed by processing circuitry, causes the processing circuitry to:
apply different effects to the input screen mapped to the first input device and the input screen mapped to the second input device for distinguishing the input screens.

21. The non-transitory computer readable recording medium of claim 17, wherein the instructions that cause the processing circuitry to display of the input screens mapped to the first and second input devices when entering a character input mode comprise instructions that, when executed by processing circuitry, causes the processing circuitry to:
create different layers and then display the input screen mapped to each input device on each of generated layers.

22. The non-transitory computer readable recording medium of claim 17, wherein the instructions that cause the processing circuitry to display of the input screens mapped to the first and second input devices when entering a character input mode comprise instructions that, when executed by processing circuitry, causes the processing circuitry to:
apply a specific effect to a component on which a user gesture is sensed and distinguish the component from other components on which the user gesture is not sensed.
